(19) United States
(12) Patent Application Publication
(10) Pub. No.: US 2020/0407834 A1
(43) Pub. Date: Dec. 31, 2020

(54) COMPOSITE COATING CONTAINING Ba2-xSrxSmTaO6 CERAMIC AND PREPARATION METHOD THEREOF

(71) Applicant: BEIJING INSTITUTE OF TECHNOLOGY, Beijing (CN)

(72) Inventors: Lihong Gao, Beijing (CN); Ma Zhuang, Beijing (CN); Fuchi Wang, Beijing (CN); Yanbo Liu, Beijing (CN); Jiayi Zheng, Beijing (CN)

(21) Appl. No.: 16/643,933

(22) PCT Filed: Nov. 8, 2017
(86) PCT No.: PCT/CN2017/000673

§ 371 Date: Mar. 3, 2020

(30) Foreign Application Priority Data
Sep. 8, 2017 (CN) 201710805637.1

(51) Int. Cl. C23C 4/073; C23C 4/02; C23C 4/11; C23C 4/134; B32B 18/00; B32B 15/04

(52) U.S. Cl. CPC C23C 4/073; C23C 4/02; B32B 15/04; C23C 4/134; B32B 18/00; C23C 4/11

(57) ABSTRACT

A composite coating containing Ba2-xSrxSmTaO6 ceramic and a preparation method thereof, which belong to the field of ceramic coating materials. The composite coating layer is of a two-layer structure composed of a metal bonding layer and a ceramic layer, the metal bonding layer being directly deposited on a substrate, and the ceramic layer being deposited on the metal bonding layer; the composite coating layer has a good protective effect against high energy lasers. The method comprises: using a thermal spraying process to sequentially spray the metal bonding layer and the ceramic layer on the substrate, and enabling a Ba2-xSrxSmTaO6 powder material to be fully melted and but not decompose in the spraying process by means of adjusting parameters of an atmospheric plasma spraying process so as to successfully achieve the preparation of a Ba2-xSrxSmTaO6 ceramic layer.

### TECHNICAL FIELD

The present invention particularly relates to a composition containing Ba₂₋ₓSrₓSmTaO₆ ceramic of a complicated perovskite structure and a preparation method thereof, and belongs to the field of ceramic coating materials.

### BACKGROUND

Along with the development of laser technology, especially constant application of high-power-density laser in the field of medical treatment, manufacturing industry and the like, security requirement targeted to laser is extremely urgent. Metal laser protective materials, such as silver, aluminium and copper, are low in melting point, poor in thermal stability and easily oxidized, and are easily melted or oxidized on the surface under the influence of heat effect of laser, resulting in sharp drop of reflectivity of the metal material and reduced dissipation capability for laser energy, as a result, security application of the metal material in high-energy-density laser is limited. While ceramic materials have the characteristics of being high in melting point, good in thermal stability and light in density, and presents unique advantages in the field of laser protection.

Ba₂SmTaO₆ is a kind of double perovskite (namely, A₂BB′O₆) type oxide ceramic material, has good high temperature phase stability, and thus is expected to be a novel protective ceramic coating. Meanwhile, researches show that introduction of Sr element at an A site can increase the state density of Sm 4f electron near a Fermi surface, and improve the reflecting property of materials, and is favorable for improving the laser protection capability. Currently, Ba₂SmTaO₆ is mostly widely used in microwave resonators and filters in the form of films with its good dielectric property and magnetic property, but there is no related report for preparation of Ba₂₋ₓSrₓSmTaO₆ ceramic protective coatings taking metal or alloy as a substrate by adopting a plasma spraying technology yet.

According to a plasma spraying technology, spraying powder particles are heated to a molten state in a certain controllable atmosphere by utilizing a heat source produced by a plasma, and molten particles are impacted and solidified on the surface of a substrate under the action of a plasma jet flow field, so as to prepare a coating with a typical lamellar structure. Due to its characteristic of complicated components and crystal structure, when a ceramic material of a double perovskite structure is subject to dual actions of high temperature and vapor pressure in a plasma flame flow, ions at a B site volatile easily, causing change of composition structure of the coating. Therefore, during spraying, it needs to adjust the process to ensure high deposition rate of a sprayed material, and high temperature oxidative decomposition is less likely to occur, so that the phase composition of the prepared coating keeps consistent to that of powder.

### SUMMARY

Aiming at deficiencies of the prior art, the present invention is directed to provide a novel composite coating containing Ba₂₋ₓSrₓSmTaO₆ ceramic, a ceramic coating in the composite coating having a good protective effect against high energy laser; the present invention is also directed to provide a method for preparing the composite coating containing Ba₂₋ₓSrₓSmTaO₆ ceramic, including: sequentially spraying metal bonding layer powder and ceramic layer powder to a substrate by adjusting parameters of the spraying process, so as to obtain the composite coating; and the method has the advantages of being simple in process, liable to control, high in production efficiency and low in cost.

The purposes of the present invention are implemented according to the following technical scheme.

A composite coating containing Ba₂₋ₓSrₓSmTaO₆ ceramic, wherein the composite coating layer is of a two-layer structure composed of a metal bonding layer and a ceramic layer, the metal bonding layer being directly deposited on a substrate, and the ceramic layer being deposited on the metal bonding layer;

the substrate being pure metal or alloy;

the thickness of the metal bonding layer being 0.1 mm˜0.2 mm, and the composition being NiCrCoAlY; and

the thickness of the ceramic layer being not smaller than 0.05 mm, and the composition being Ba₂₋ₓSrₓSmTaO₆, 0≤x≤2.

Preparation of the composite coating containing Ba₂₋ₓSrₓSmTaO₆ ceramic according to the present invention, including the following specific steps:

step 1. cleaning a to-be-sprayed surface of a substrate, to remove impurities such as dust and greasy dirt adhering to the surface of the substrate, and performing roughening treatment on the surface to cause the roughness (Ra) to reach 3 μm˜7 μm;

step 2. before spraying, performing preheating treatment on a to-be-sprayed substrate, controlling substrate temperature at 100˜200° C.;

step 3. feeding NiCrCoAlY alloy powder into a powder feeder, and spraying a metal bonding layer to the to-be-sprayed surface of the substrate by adopting a thermal spraying process; and

step 4. feeding Ba₂₋ₓSrₓSmTaO₆ ceramic powder into the powder feeder, spraying a ceramic layer to the substrate already sprayed with the metal bonding layer by adopting an atmospheric plasma spraying process, and cooling the substrate by adopting compressed air in a spraying process to form the composite coating on the substrate after spraying of the ceramic layer is ended.

Optimally, specific process parameters for spraying the metal bonding layer by adopting a plasma spraying process are: main gas flow being 45 L/min˜60 L/min, auxiliary gas flow being 5 L/min˜7 L/min, carrier gas flow being 4 L/min˜6 L/min, current being 600 A˜750 A, spraying distance being 70 mm˜100 mm, powder feeding quantity being 35 g/min˜60 g/min, main gas and carrier gas being both argon, auxiliary gas being helium, and particle size of the NiCrCoAlY alloy powder being optimally 20 μm˜80 μm.

Process parameters for spraying a ceramic layer by adopting an atmospheric plasma spraying process are: main gas flow being 40 L/min˜55 L/min, auxiliary gas flow being 10 L/min˜15 L/min, carrier gas flow being 4 L/min˜6 L/min, current being 700 A˜800 A, spraying distance being 85 mm˜100 mm, powder feeding quantity being 45 g/min˜65 g/min, main gas and carrier gas being both argon, auxiliary gas being helium, and particle size of Ba₂₋ₓSrₓSmTaO₆ ceramic powder being optimally 30 μm˜80 μm.

When performing spraying of the metal bonding layer and the ceramic layer, the spraying angle of a spray gun is 80°˜90°.

The present invention has the following beneficial effects:

(1) Ba₂₋ₓSrₓSmTaO₆ is a double perovskite type ceramic material formed by high-price large-mass rare earth ions, and has the characteristics of relatively high melting point and reflectivity; meanwhile, a plasma spraying coating has a lamellar structure, which is beneficial for horizontal evacuation of laser local energy, and favorable for protecting a substrate material; and

(2) according to the present invention, by adjusting parameters of the atmospheric plasma spraying process, the Ba₂₋ₓSrₓSmTaO₆ powder material is sufficiently melted without decomposition in a spraying process, so as to successfully achieve the preparation of a Ba₂₋ₓSrₓSmTaO₆ ceramic layer; the method disclosed by the present invention has the advantages of being simple in process, liable to control, high in production efficiency and low in cost.

### BRIEF DESCRIPTION OF THE DRAWINGS

FIG. 1 is a comparison diagram of X ray diffraction (XRD) spectrograms of a Ba₂SmTaO₆ ceramic layer and Ba₂SmTaO₆ ceramic powder in the composite coating prepared in embodiment 1.

FIG. 2 is a scanning electron microscope (SEM) diagram of the surface of the Ba₂SmTaO₆ ceramic layer in the composite coating prepared in embodiment 1.

FIG. 3 is a comparison diagram of X ray diffraction (XRD) spectrogram of a Ba_{0.5}SR_{1.5}SmTaO₆ ceramic layer and Ba_{0.5}SR_{1.5}SmTaO₆ ceramic powder in the composite coating prepared in embodiment 2.

FIG. 4 is a scanning electron microscope diagram of the surface of the Ba_{0.5}SR_{1.5}SmTaO₆ ceramic layer in the composite coating prepared in embodiment 2.

### DESCRIPTION OF THE EMBODIMENTS

The following further describes the present invention with reference to specific embodiments. The methods, unless otherwise specified, are conventional methods, and the raw materials, unless otherwise specified, may be all obtained from public commercial paths.

In the following embodiments:

45 #steel: GB/T699-1999, Beijing Jingfuwan Trading Co. LTD;

An optical fiber continuous laser: YSL-2000, IPG Photon Company;

A spray gun: SG100, American Praxair Co., LTD; and

A powder feeder: MODEL 1264, American Praxair Co., LTD.

### Embodiment 1

Step 1. cleaning a to-be-sprayed surface of 45 #steel by using analytically pure acetone, to remove impurities such as dust and greasy dirt adhering to the surface of the 45 #steel; then performing sand blasting treatment on the to-be-sprayed surface by adopting white emery of 20-60 meshes, and blowing away all white emery remaining on the surface of 45 #steel by adopting compressed air, so that roughness (Ra) of the to-be-sprayed surface reaches 6 μm;

step 2. clamping a corresponding fixture for 45 #steel on a workbench, and setting a spraying travelling route procedure for a manipulator provided with a spray gun, keeping a spraying angle of the spray gun at 90°; and before spraying, performing preheating treatment on 45 #steel, controlling temperature of 45 #steel at 130° C.;

step 3. feeding NiCrCoAlY alloy powder with particle size of 20 μm˜80 μm into a powder feeder, and spraying a metal bonding layer to a to-be-sprayed surface of 45 #steel by adopting a plasma spraying process;

process parameters for plasma spraying are: spray gun SG100, main gas flow being 60 L/min, auxiliary gas flow being 5 L/min, carrier gas flow being 6 L/min, current being 600 A, spraying distance being 70 mm, powder feeding quantity being 35 g/min, main gas and carrier gas being both argon, auxiliary gas being helium, and thickness of the bonding layer being 0.15 mm; and

step 4. feeding Ba₂SmTaO₆ ceramic powder with particle size of 30 μm˜80 μm into a powder feeder, spraying a ceramic layer to 45 #steel already sprayed with the metal bonding layer by adopting a plasma spraying process, and cooling 45 #steel by adopting compressed air in a spraying process to form the composite coating containing Ba₂SmTaO₆ ceramic on 45 #steel after spraying of the ceramic layer is ended;

process parameters for atmospheric plasma spraying are: spray gun SG100, main gas flow being 40 L/min, auxiliary gas flow being 15 L/min, carrier gas flow being 4 L/min, current being 800 A, spraying distance being 100 mm, powder feeding quantity being 65 g/min, main gas and carrier gas being both argon, auxiliary gas being helium, and thickness of the ceramic layer being 0.15 mm.

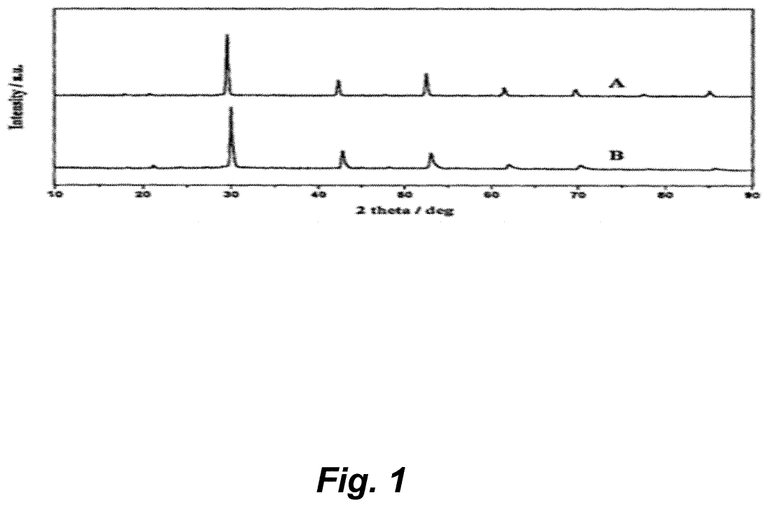

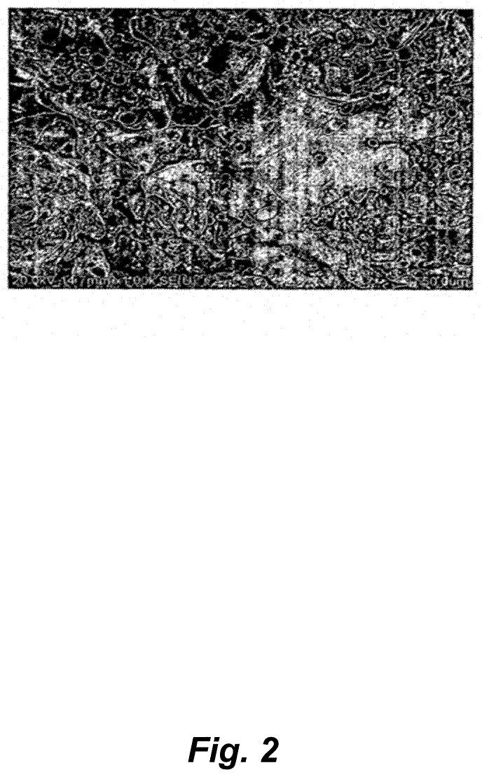

In FIG. 1, A is an XRD spectrogram of the Ba₂SmTaO₆ ceramic powder in step 4, B is an XRD spectrogram of a ceramic layer in the composite coating prepared in the present embodiment, and it is seen from FIG. 1 that XRD spectrograms of the prepared ceramic layer and the Ba₂SmTaO₆ ceramic powder present high consistency, indicating that the Ba₂SmTaO₆ ceramic powder is sufficiently melted without high temperature oxidative decomposition in a plasma spraying process, and the phase of Ba₂SmTaO₆ in the prepared ceramic layer keeps consistence to that of Ba₂SmTaO₆ ceramic powder before spraying. FIG. 2 is an SEM diagram of the surface of a prepared ceramic layer, and it is seen from FIG. 2 that Ba₂SmTaO₆ ceramic powder particles are melted thoroughly in the coating, and melted powder particles generate deformation after touching the metal bonding layer, and are better in spreading, shown by smooth coating surface appearance, and it is measured that the roughness Ra of the surface of the prepared ceramic layer is 5 μm.

Performing irradiation damage test on the ceramic layer on the surface layer of the prepared composite material by adopting a YSL-2000 type optical fiber continuous laser, wherein irradiation wavelength is 1070 nm, irradiation power density is 500 W/cm², and irradiation time is 10 s; it is known by observing the macroscopic surface appearance of the prepared ceramic layer before and after irradiation that the surface of the coating is not changed obviously and not damaged after irradiation with laser, thereby achieving a protective effect against high energy laser.

### Embodiment 2

Step 1. cleaning a to-be-sprayed surface of 45 #steel by using analytically pure acetone, to remove impurities such as dust and greasy dirt adhering to the surface of the 45 #steel; then performing sand blasting treatment on the to-be-sprayed surface by adopting white emery of 20-60 meshes, and blowing away all white emery remaining on the surface of 45 #steel by adopting compressed air, so that roughness (Ra) of the to-be-sprayed surface reaches 4 μm;

step 2. clamping a corresponding fixture for 45 #steel on a workbench, and setting a spraying travelling route procedure for a manipulator provided with a spray gun, keeping a spraying angle of the spray gun at 90°; and before spraying, performing preheating treatment on 45 #steel, controlling temperature of 45 #steel at 180° C.;

step 3. feeding NiCrCoAlY alloy powder with particle size of 20 μm˜80 μm into a powder feeder, and spraying a metal bonding layer on a to-be-sprayed surface of 45 #steel by adopting a plasma spraying process;

process parameters for plasma spraying are: spray gun SG100, main gas flow being 45 L/min, auxiliary gas flow being 7 L/min, carrier gas flow being 4 L/min, current being 750 A, spraying distance being 100 mm, powder feeding quantity being 60 g/min, main gas and carrier gas being both argon, auxiliary gas being helium, and thickness of the bonding layer being 0.15 mm; and

step 4. feeding Ba_{0.5}Sr_{1.5}SmTaO₆ ceramic powder with particle size of 30 μm˜80 μm into a powder feeder, spraying a ceramic layer to 45 #steel already sprayed with the metal bonding layer by adopting a plasma spraying process, and cooling 45 #steel by adopting compressed air in a spraying process to form the composite coating containing Ba_{0.5}Sr_{1.5}SmTaO₆ ceramic on 45 #steel after spraying of the ceramic layer is ended;

process parameters for atmospheric plasma spraying are: spray gun SG100, main gas flow being 55 L/min, auxiliary gas flow being 10 L/min, carrier gas flow being 6 L/min, current being 700 A, spraying distance being 85 mm, powder feeding quantity being 45 g/min, main gas and carrier gas being both argon, auxiliary gas being helium, and thickness of the ceramic layer being 0.15 mm.

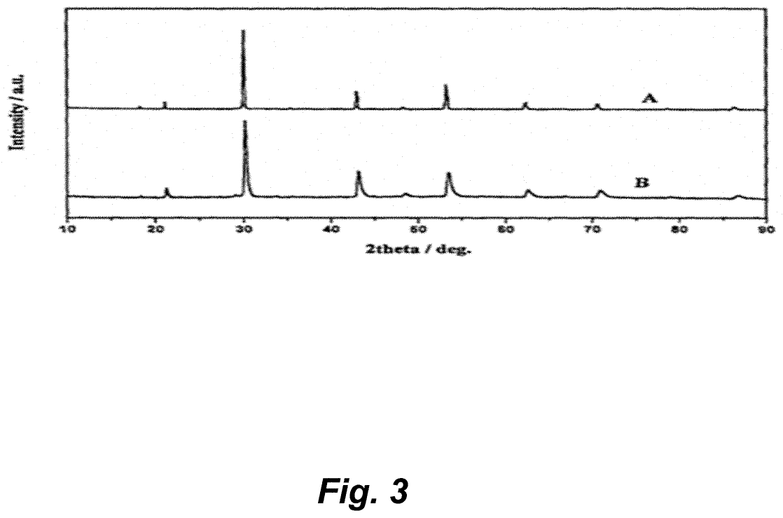

In FIG. 3, A is an XRD spectrogram of the Ba_{0.5}Sr_{1.5}SmTaO₆ ceramic powder in step 4, B is an XRD spectrogram of a ceramic layer in the composite coating prepared in the present embodiment, and it is seen from FIG. 3 that XRD spectrograms of the prepared ceramic layer and the Ba_{0.5}Sr_{1.5}SmTaO₆ ceramic powder present high consistency, indicating that the Ba_{0.5}Sr_{1.5}SmTaO₆ ceramic powder is sufficiently molted without high temperature oxidative decomposition in a plasma spraying process, and the phase of Ba_{0.5}Sr_{1.5}SmTaO₆ in the prepared ceramic layer keeps consistence to that of Ba_{0.5}Sr_{1.5}SmTaO₆ ceramic powder before spraying.

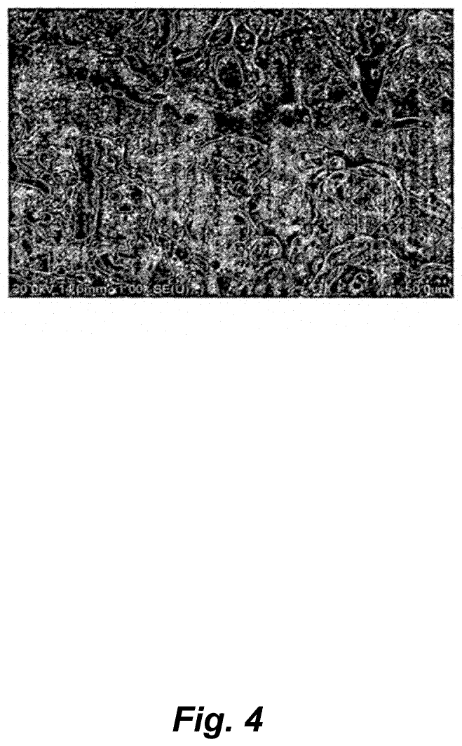

FIG. 4 is an SEM diagram of the surface of a prepared ceramic layer, and it is seen from FIG. 4 that Ba_{0.5}Sr_{1.5}SmTaO₆ ceramic powder particles are melted thoroughly in the coating, and melted powder particles generate deformation after touching the metal bonding layer, and are better in spreading, shown by smooth coating surface appearance, and it is measured that the roughness Ra of the surface of the prepared ceramic layer is 6 μm.

Performing irradiation damage test on the ceramic layer on the surface layer of the prepared composite material by adopting a YSL-2000 type optical fiber continuous laser, wherein irradiation wavelength is 1070 nm, irradiation power density is 500 W/cm², and irradiation time is 10 s; it is known by observing the surface macroscopic appearance of the prepared ceramic layer before and after irradiation that the surface of the coating is not changed obviously and not damaged after irradiation with laser, thereby achieving a protective effect against high energy laser.

The present invention includes but is not limited to the foregoing embodiments, any equivalent substitution or local improvement made within the spirit and principle of the present invention should be deemed as falling within the protection scope of the present invention.

1. A composite coating containing Ba₂₋ₓSrₓSmTaO₆ ceramic, wherein the composite coating layer is of a two-layer structure composed of a metal bonding layer and a ceramic layer, the metal bonding layer being directly deposited on a substrate, and the ceramic layer being deposited on the metal bonding layer;
the substrate being pure metal or alloy;
the composition of the metal bonding layer being NiCrCoAlY; and
the composition of the ceramic layer being Ba2-xSrxSmTaO6, 0≤x≤2.

2. The composite coating containing Ba₂₋ₓSrₓSmTaO₆ ceramic according to claim 1, wherein the thickness of the metal bonding layer is 0.1 mm˜0.2 mm.

3. The composite coating containing Ba₂₋ₓSrₓSmTaO₆ ceramic according to claim 1, wherein the thickness of the ceramic layer is not smaller than 0.05 mm.

4. A preparation method of a composite coating containing Ba2-xSrxSmTaO6 ceramic, comprising the following steps:
step 1. cleaning a to-be-sprayed surface of a substrate, and performing roughening treatment on the surface to cause the roughness to reach 3 μm˜7 μm;
step 2. before spraying, performing preheating treatment on a to-be-sprayed substrate, controlling substrate temperature at 100˜200° C.;
step 3. feeding NiCrCoAlY alloy powder into a powder feeder, and spraying a metal bonding layer to the to-be-sprayed surface of the substrate by adopting a thermal spraying process; and
step 4. feeding Ba₂₋ₓSrₓSmTaO₆ ceramic powder into the powder feeder, spraying a ceramic layer to the substrate already sprayed with the metal bonding layer by adopting an atmospheric plasma spraying process, and cooling the substrate by adopting compressed air in a spraying process to form the composite coating on the substrate;
process parameters for spraying a ceramic layer by adopting an atmospheric plasma spraying process are: main gas flow being 40 L/min˜55 L/min, auxiliary gas flow being 10 L/min˜15 L/min, carrier gas flow being 4 L/min˜6 L/min, current being 700 A˜800 A, spraying distance being 85 mm˜100 mm, powder feeding quantity being 45 g/min˜65 g/min, main gas and carrier gas being both argon, and auxiliary gas being helium.

5. The preparation method of the composite coating containing Ba2-xSrxSmTaO6 ceramic according to claim 4, wherein a particle size of the Ba2-xSrxSmTaO6 ceramic powder is 30 μm˜80 μm.

6. The preparation method of the composite coating containing Ba2-xSrxSmTaO6 ceramic according to claim 4, wherein specific process parameters for spaying the metal bonding layer by adopting a plasma spraying process are: main gas flow being 45 L/min˜60 L/min, auxiliary gas flow being 5 L/min˜7 L/min, carrier gas flow being 4 L/min˜6 L/min, current being 600 A˜750 A, spraying distance being 70 mm˜100 mm, powder feeding quantity being 35 g/min˜60 g/min, main gas and carrier gas being both argon, and auxiliary gas being helium.

7. The preparation method of the composite coating containing Ba2-xSrxSmTaO6 ceramic according to claim 4, wherein a particle size of the NiCrCoAlY alloy powder is 20 μm˜80 μm.

8. The preparation method of the composite coating containing Ba2-xSrxSmTaO6 ceramic according to claim 4, wherein when performing spraying of the metal bonding layer and the ceramic layer, a spraying angle of a spray gun is 80°˜90°.

9. A preparation method of a composite coating containing Ba₂₋ₓSrₓSmTaO₆ ceramic, the method being applicable to the composite coating containing Ba₂₋ₓSrₓSmTaO₆ ceramic according to claim 1, the method comprising the following steps:
step 1. cleaning a to-be-sprayed surface of a substrate, and performing roughening treatment on the surface to cause the roughness to reach 3 μm˜7 μm;
step 2. before spraying, performing preheating treatment on a to-be-sprayed substrate, controlling substrate temperature at 100˜200° C.;
step 3. feeding NiCrCoAlY alloy powder into a powder feeder, and spraying a metal bonding layer to the to-be-sprayed surface of the substrate by adopting a thermal spraying process; and
step 4. feeding Ba₂₋ₓSrₓSmTaO₆ ceramic powder into the powder feeder, spraying a ceramic layer to the substrate already sprayed with the metal bonding layer by adopting an atmospheric plasma spraying process, and cooling the substrate by adopting compressed air in a spraying process to form the composite coating on the substrate;
process parameters for spraying a ceramic layer by adopting an atmospheric plasma spraying process are: main gas flow being 40 L/min˜55 L/min, auxiliary gas flow being 10 L/min˜15 L/min, carrier gas flow being 4 L/min˜6 L/min, current being 700 A˜800 A, spraying distance being 85 mm˜100 mm, powder feeding quantity being 45 g/min˜65 g/min, main gas and carrier gas being both argon, and auxiliary gas being helium.

10. The preparation method of the composite coating containing Ba₂₋ₓSrₓSmTaO₆ ceramic according to claim 9, wherein a particle size of the Ba₂₋ₓSrₓSmTaO₆ ceramic powder is 30 μm˜80 μm.

11. The preparation method of the composite coating containing Ba₂₋ₓSrₓSmTaO₆ ceramic according to claim 9, wherein specific process parameters for spaying the metal bonding layer by adopting a plasma spraying process are: main gas flow being 45 L/min˜60 L/min, auxiliary gas flow being 5 L/min˜7 L/min, carrier gas flow being 4 L/min˜6 L/min, current being 600 A˜750 A, spraying distance being 70 mm˜100 mm, powder feeding quantity being 35 g/min˜60 g/min, main gas and carrier gas being both argon, and auxiliary gas being helium.

12. The preparation method of the composite coating containing Ba₂₋ₓSrₓSmTaO₆ ceramic according to claim 9, wherein a particle size of the NiCrCoAlY alloy powder is 20 μm˜80 μm.

13. The preparation method of the composite coating containing Ba₂₋ₓSrₓSmTaO₆ ceramic according to claim 9, wherein when performing spraying of the metal bonding layer and the ceramic layer, a spraying angle of a spray gun is 80°˜90°.

14. A preparation method of a composite coating containing Ba₂₋ₓSrₓSmTaO₆ ceramic, the method being applicable to the composite coating containing Ba₂₋ₓSrₓSmTaO₆ ceramic according to claim 2, the method comprising the following steps:
step 1. cleaning a to-be-sprayed surface of a substrate, and performing roughening treatment on the surface to cause the roughness to reach 3 μm˜7 μm;
step 2. before spraying, performing preheating treatment on a to-be-sprayed substrate, controlling substrate temperature at 100˜200° C.;
step 3. feeding NiCrCoAlY alloy powder into a powder feeder, and spraying a metal bonding layer to the to-be-sprayed surface of the substrate by adopting a thermal spraying process; and
step 4. feeding Ba₂₋ₓSrₓSmTaO₆ ceramic powder into the powder feeder, spraying a ceramic layer to the substrate already sprayed with the metal bonding layer by adopting an atmospheric plasma spraying process, and cooling the substrate by adopting compressed air in a spraying process to form the composite coating on the substrate;
process parameters for spraying a ceramic layer by adopting an atmospheric plasma spraying process are: main gas flow being 40 L/min˜55 L/min, auxiliary gas flow being 10 L/min˜15 L/min, carrier gas flow being 4 L/min˜6 L/min, current being 700 A˜800 A, spraying distance being 85 mm˜100 mm, powder feeding quantity being 45 g/min˜65 g/min, main gas and carrier gas being both argon, and auxiliary gas being helium.

15. The preparation method of the composite coating containing Ba₂₋ₓSrₓSmTaO₆ ceramic according to claim 10, wherein a particle size of the Ba₂₋ₓSrₓSmTaO₆ ceramic powder is 30 μm˜80 μm.

16. The preparation method of the composite coating containing Ba₂₋ₓSrₓSmTaO₆ ceramic according to claim 10, wherein specific process parameters for spaying the metal bonding layer by adopting a plasma spraying process are: main gas flow being 45 L/min˜60 L/min, auxiliary gas flow being 5 L/min˜7 L/min, carrier gas flow being 4 L/min˜6 L/min, current being 600 A˜750 A, spraying distance being 70 mm˜100 mm, powder feeding quantity being 35 g/min˜60 g/min, main gas and carrier gas being both argon, and auxiliary gas being helium.

17. The preparation method of the composite coating containing Ba₂₋ₓSrₓSmTaO₆ ceramic according to claim 10, wherein a particle size of the NiCrCoAlY alloy powder is 20 μm˜80 μm.

18. The preparation method of the composite coating containing Ba₂₋ₓSrₓSmTaO₆ ceramic according to claim 10, wherein when performing spraying of the metal bonding layer and the ceramic layer, a spraying angle of a spray gun is 80°˜90°.

19. A preparation method of a composite coating containing Ba₂₋ₓSrₓSmTaO₆ ceramic, the method being applicable to the composite coating containing Ba₂₋ₓSrₓSmTaO₆ ceramic according to claim 3, the method comprising the following steps:
step 1. cleaning a to-be-sprayed surface of a substrate, and performing roughening treatment on the surface to cause the roughness to reach 3 μm˜7 μm;
step 2. before spraying, performing preheating treatment on a to-be-sprayed substrate, controlling substrate temperature at 100˜200° C.;
step 3. feeding NiCrCoAlY alloy powder into a powder feeder, and spraying a metal bonding layer to the to-be-sprayed surface of the substrate by adopting a thermal spraying process; and
step 4. feeding Ba₂₋ₓSrₓSmTaO₆ ceramic powder into the powder feeder, spraying a ceramic layer to the substrate already sprayed with the metal bonding layer by adopting an atmospheric plasma spraying process, and cooling the substrate by adopting compressed air in a spraying process to form the composite coating on the substrate;
process parameters for spraying a ceramic layer by adopting an atmospheric plasma spraying process are: main gas flow being 40 L/min˜55 L/min, auxiliary gas flow being 10 L/min˜15 L/min, carrier gas flow being 4 L/min˜6 L/min, current being 700 A˜800 A, spraying distance being 85 mm˜100 mm, powder feeding quantity being 45 g/min˜65 g/min, main gas and carrier gas being both argon, and auxiliary gas being helium.

20. The preparation method of the composite coating containing Ba₂₋ₓSrₓSmTaO₆ ceramic according to claim 11, wherein a particle size of the Ba₂₋ₓSrₓSmTaO₆ ceramic powder is 30 μm˜80 μm.
